(19) United States
(12) Patent Application Publication
(10) Pub. No.: US 2002/0136593 A1
(43) Pub. Date: Sep. 26, 2002

(54) Assembly

(76) Inventor: Sidney Edward Fisher, West Midlands (GB)

Correspondence Address: CARLSON, GASKEY & OLDS, P.C., 400 WEST MAPLE ROAD, SUITE 350, BIRMINGHAM, MI, 48009, US

(21) Appl. No.: 10/098,956

(22) Filed: Mar. 15, 2002

(30) Foreign Application Priority Data
Mar. 21, 2001 (GB) GB 0107065.5

(51) Int. Cl. F16B 1/00; B25G 3/28; F16G 11/00

(52) U.S. Cl. 403/279

(57) ABSTRACT

An assembly including a first component and a second component, the first component having a first deformed portion, in which the first deformed portion engages with the second component to allow rotation therebetween and the first deformed portion secures the first component to the second component.

### BACKGROUND OF THE INVENTION

This application claims priority to Great Britain patent application GB 010 7065.5 filed Mar. 21, 2001.

The present invention relates to assemblies and in particular assemblies of components used in land vehicles such as cars.

Assemblies in which components are secured together by fixing mechanisms such as nuts and bolts or rivets are known.

To reduce the weight of assemblies it is desirable to reduce the number of overall components, and hence secure components without the use of such fixing mechanisms. By deforming the components into an interlocking relationship and therefore securing themselves relative to each other, the need for such fixing mechanisms is eliminated, thereby limiting the number of overall components in the assembly.

Such deformation techniques are known, with the TOG-L-LOC□ (a trademark of BTM Corp. of Marysville, Mich., USA) system being one example (see U.S. Pat. No. 5,984,563 dated Nov. 16, 1999 and U.S. Pat. No. 5,267,383 dated Dec. 7, 1993). These techniques can be used to secure various components (see U.S. Pat. No. 4,827,671 dated May 9, 1989 and U.S. Pat. No. 4,800,638 dated Jan. 31, 1989). The hemming of sheet metal components is another example which can be used to secure assemblies.

However such assemblies secured by deformation techniques and fixing mechanisms do not allow free rotation of components relative to each other, and thus cannot be used for assemblies which do require rotation relative to each other.

### SUMMARY OF THE INVENTION

It is possible to use a single nut and bolt to secure an assembly which requires components to rotate relative to each other but this results in an additional component being required.

Therefore an object of the present invention is to provide an improved assembly in which the number of overall components is reduced, with the components being secured but also being capable of rotating relative to each other.

Thus according to the present invention there is provided an assembly including a first component and a second component, the first component having a first deformed portion, in which the deformed portion engages with the second component to allow rotation there between and the first deformed portion secures the first component to the second component.

### BRIEF DESCRIPTION OF THE DRAWINGS

The invention will now be described, by way of example only, with reference to the accompanying drawings in which:

FIG. 1 is a cross sectional view of an assembly according to the present invention,

FIG. 2 is a cross sectional view of an alternative assembly according to the present invention, and

FIG. 3 is a front view of a vehicle door including an assembly according to the present invention.

### DETAILED DESCRIPTION OF PREFERRED EMBODIMENTS

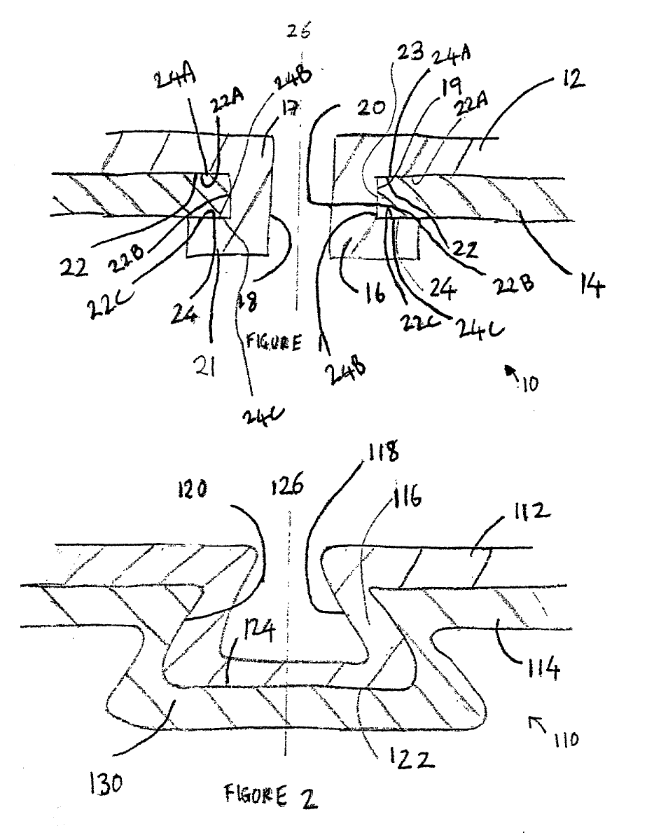

With reference to FIG. 1 there is shown an assembly 10 including a first component 12 and a second component 14.

The first component 12 and the second component 14 can be produced from a sheet steel and are typically pressed.

The first component 12 includes a first deformed portion 16.

The first deformed portion 16 includes a cylindrical portion 17 and an annular flange 21 contiguous with the end of the cylindrical portion 17.

The cylindrical portion 17 defines a through hole 18 and a radially outwardly orientated wall 19, the through hole 18 and wall 19 being circular.

The cylindrical portion 17 in conjunction with the annular flange 21 acts to limit axial and radial movement between the first 12 and second 14 component.

The second component 14 has a second through hole 20, which is a circular hole. The second hole 20 has a radially inwardly orientated wall 23.

The deformed portion 16 engages with the second component 14 to secure the second component 14 to the first component 12.

The engagement between the deformed portion 16 and the second component 14 permits the second component 14 to rotate relative to the first component 12 about an axis 26.

Thus, engagement between the deformed portion 16 of the first component 12 and the second component 14 defines a first bearing surface 22 (comprising surfaces 22A, 22B, and 22C) of the first component 12 and a second bearing surface 24 (comprising surfaces 24A, 24B and 24C) of the second component 14.

The outwardly orientated wall 19 forms surface 22B.

The inwardly orientated wall 23 forms surface 24B.

In this embodiment it can be seen that a suitable pressing process is required to deform the first component 12 such that it is secured to the second component 14. This pressing process can include several stages with a first stage to produce the cylindrical portion 17. Part of the cylindrical portion 17 then protrudes through the hole 20 of the second component 14. A final pressing stage is then employed to deform the end of this cylindrical portion to produce the annular flange 21.

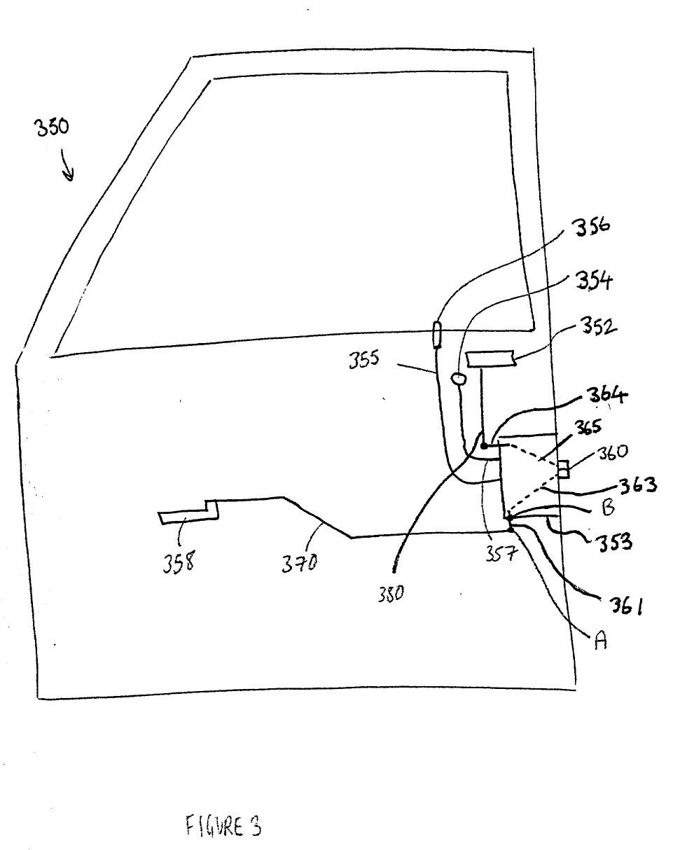

With reference to FIG. 2 there is shown an alternative assembly 110.

This assembly includes the same functional features of FIG. 1, but numbered 100 greater. However in this embodiment engagement between the first 112 and second 114 components is different.

The first component 112 includes a first deformed portion 116 which defines a blind hole 118. Hole 118 is a circular hole.

The first deformed portion 116 is substantially in the shape of the Greek symbol Omega (Ω).

The second component 114 includes a second deformed portion 130, the second deformed portion being substantially in the shape of the Greek symbol Omega (Ω).

The second deformed portion 130 defines a second blind hole 120.

The second deformed portion 130 engages with the deformed portion 116 of the first component 112 to secure the second component 114 to the first component 112.

Engagement between the deformed portions permits the second component 114 to rotate relative to the first component 112 about an axis 126.

Engagement between the deformed portion 116 of the first component 112 and the deformed portion 130 of the second component 114 defines a first bearing surface 122 of the first component 112 and a second bearing surface 124 of the second component 114.

In this embodiment it can be seen that a suitable pressing process is required to deform the first component 112 such that it is secured to the second component 114. This pressing process can include several stages with a first stage to produce part of the deformed portions 116, 130 of the first 112 and 114 second components, the deformed portions 116, 130 defining the blind holes 118, 120. The blind holes 118, 120 are then subjected to a stage which includes lateral extrusion, to further deform the blind holes 118, 120 such that the blind holes 118, 120 interlock and hence secure the first component 112 to the second component 114.

Note that in this embodiment the pressing stage to produce the deformed portions 116, 130 does not result in the piercing of the components 112, 114, and consequently any coating applied to the components 112, 114, in particular the bearing surfaces 122, 124, will not comprise the integrity of the components, and hence coating life will be prolonged.

Note that in a further embodiment the second hole 120 may be a blind hole, with a deformed portion 116 of the first component 112 being a through hole and engaging with the blind hole 120 to secure the first component 112 to the second component.

In the embodiments of FIG. 1 and FIG. 2 the pressing process, and hence the form of the deformed portions 16, 116, 130 is designed such that the first 12, 112 and second 14, 114 components are free to rotate relative to each other, but not so loose as to result in excessive rattle between the components 12, 14, 112, 114.

A coating may be applied to the first bearing surface 22, 122, the coating being selected to provide high wear resistance when compared to the material of the first component 12, 112. For example a metallic coating such as copper, or a plastic coating such as Polytetraflouroethene (PTFE) may be used.

The coating can be any material which provides high wear resistance and/or lower friction compared to the material of the first component 12, 112 when combined with the material of the second component 14, 114.

Alternatively, or additionally, a similar coating may be applied to the second bearing surface 24, 124.

The first 12, 112 and/or second 14, 114 component may also be subjected to a surface treatment process such as carburizing or induction hardening to provide a similar high wear resistant surface.

The coatings on the first 12, 112 and/or second 14, 114 components can have specified thicknesses which may be controlled to tailor the fit between the two components 12, 14, 112, 114 such that it is rattle free and allows rotation between the two components 12, 14, 112, 114.

Note that in the embodiment of FIG. 1, a coating applied to both surfaces of the second component 14 prior to pressing of hole 20 will be broken when hole 20 is pierced during the pressing process, and hence there will be no coating on the inwardly facing wall 23 (i.e. bearing surface 24B). However a coating applied to the first bearing surface 22 (i.e. surfaces 22A, 22B, and 22C) prior to deforming will not be broken since the coating will not be pierced. Hence a coating will be present at surface 22B for engagement with uncoated bearing surface 24B.

Preferably the coating selected for the first bearing surface 22 is sufficiently ductile to maintain integrity during the pressing process.

Alternatively the bearing surface 24B can be coated after the through hole 20 has been pierced and hence a coating will be present at surface 24B for engagement with either a coated or uncoated bearing surface 24B.

In the embodiment of FIG. 2 the first 112 and second 114 components are not pierced during the pressing process and hence any coating applied to the first 122 and/or second 124 bearing surface remains unbroken providing the coating is sufficiently ductile to maintains its integrity during the pressing process.

Note that in further embodiments the inwardly facing wall 19 and the outwardly facing wall 23 need not both be circular, with one of the inwardly facing wall 19 or the outwardly facing wall 23 being non circular.

Similarly, in the embodiment of FIG. 2 the first hole 118 and the second hole 120 need not both be circular holes, with one of the first 118 and second 120 holes being a non circular hole.

With reference to FIG. 3 there is shown a vehicle door 350.

The vehicle door 350 includes a vehicle door latch 353, a sill button 356, a key barrel 354, an inside door handle 358, and an outside door handle 352.

The vehicle door latch 353 includes a latch bolt 360 which operates to releasably retain the vehicle door 350 in a closed position. The latch bolt 360 is mounted on the vehicle door latch 353.

The key barrel 354 is connected to the vehicle door latch 353 by a first transmission path 357. The key barrel 354 operates to lock and unlock the vehicle door.

The sill button 356 is connected to the vehicle door latch 353 by a second transmission path 355. The sill button 356 operates to lock and unlock the vehicle door 350.

The inside door handle 358 is connected to an input element of the latch 353 in the form of a first lever 361, by a third transmission path 370. The first lever 361 is connected to the latch bolt 360 by a first latch transmission path 363 (shown schematically).

It can be seen that the third transmission path 370, the first lever 361 and the first latch transmission path 363 together form a transmission path between the inside door handle 358 and the latch bolt 360.

The outside door handle 352 is connected to an input element of the latch 353, in the form of a second lever 364, by a fourth transmission path 380. The second lever 364 is connected to the latch bolt 360 by a second latch transmission path 365 (shown schematically).

It can be seen that the fourth transmission path 380, the second lever 364 and the second latch transmission path 365 together form a transmission path between the outside door handle 352 and the latch bolt 360.

It should be noted that the key barrel 354, the sill button 356, the inside handle 358 and the outside handle 352 are all manually actuable elements.

Transmission paths 355, 357, 363, 365, 370 and 380 and input elements 364 and 361 can take many forms, typically rods and levers. A particular installation may require two adjacent parts of a transmission path to be pivoted together and an assembly according to the present invention can be used to provide such pivoting movement, for example an end of the third transmission path 370 can form a first component 12, 112 according to the present invention which can be connected to an end of the input element 361 (which forms the second component 14, 114) to provide for a pivotal connection at position A.

Alternatively a component of a transmission path can be pivotally mounted relative to a stationary component such as a latch chassis or a part of the vehicle door via an assembly according to the present invention, for example input element 361 can form a first component 12, 112 according to the present invention which can be connected to the latch chassis (which forms the second component) 14, 114 to provide for a pivotal connection at position B.

In other embodiments any component of the transmission paths 370, 355, 357 or 380 can be connected to the door 350 which can form the first 12, 112 or second 14, 114 component.

Two types of locking are known, free wheel type locking and block type locking.

In a free wheel type locking system a break in the fourth transmission path 380 between the outside door handle 352 and the latch 360 bolt prevents the latch bolt 360 from being released when the latch 353 is locked. With the latch 353 unlocked the transmission path 380 is complete and operation of the outside door handle 352 will release the latch bolt 360. In a free wheel type locking system the outside door handle 352 is always free to move, but will only release the latch bolt 360 when the latch 353 is unlocked.

In a block locking type system the fourth transmission path 380 between the outside door handle 352 and the latch bolt 360 is blocked such that with the latch 353 in a locked condition the latch bolt 360 is not released. With the latch 353 unlocked the transmission path 380 is unblocked and operation of the outside door handle 352 will release the latch bolt 360. In a block type locking system the outside door handle 352 is only free to move when the latch 353 is unlocked.

When the vehicle door 350 is fitted with a free wheel type locking system, an assembly according to the present invention can be fitted into the fourth transmission path 380 (either in the latch 353 or between the latch 353 and outside door handle 352) such that the first 12, 112 and second 14, 114 component are selectively couplable and decouplable to provide the break in the transmission path 380.

Thus with the vehicle door latch 353 in a locked condition (as a result of either sill button 356, key barrel 354 or some other remote electronic operation), the first 12, 112 and second 14, 114 components are uncoupled and operation of the outside door handle 352 causes the first 12, 112 and second 14, 114 components to rotate relative to each other, thus breaking the fourth transmission path 380 between the outside door handle 352 and the latch bolt 360, such that the latch bolt 360 does not move and the vehicle door 350 remains closed. Thus the outside door handle 352 being connected to one of the first 12, 112 and second 14, 114 components will be moved, but will not release the latch bolt 360.

Furthermore with the vehicle door latch 353 in an unlocked condition (as a result of either sill button 356, key barrel 354 or some other remote electronic operation), the first 12, 112 and second 14, 114 components are coupled and operation of the outside door handle 352 causes the first 12, 112 and second 14, 114 components to move such that the fourth transmission path 380 between the outside door handle 352 and the latch bolt 360 is complete and the latch bolt 360 moves and releases the vehicle door 350. Thus the outside door handle 352 being connected to the first 12, 112 and second 14, 114 components will be moved, and release the latch bolt 360.

When the vehicle door 350 is fitted with a block type locking system, then an assembly according to the present invention can be fitted into the fourth transmission path 380 (either in the latch or between the latch and handle) such that the transmission path 380 is either selectively blocked or unblocked by one of the first 12, 112 and second 14, 114 components.

Thus with the vehicle door latch 353 in a locked condition, the fourth transmission path 380 between the outside door handle 352 and the latch bolt 360 is blocked by either the first 12, 112 or second 14, 114 component, such that the outside door handle 352 will not move, and will not result in movement of the latch bolt 360.

With the vehicle door latch 353 in an unlocked condition the fourth transmission path 380 between the outside door handle 352 and the latch bolt 360 is not blocked, i.e., all parts of the transmission path 380 are free to move, and operation of the outside door handle 352 will move and release the latch bolt 360.

Similarly, the inside door handle 358 can also operate on a free wheel or block locking principle, with the third transmission path 370 between the inside door handle 358 and the latch bolt 360 arranged to include an assembly according to the present invention. The transmission path is either blocked/unblocked or broken/unbroken.

The blocking/breaking of the third transmission path 370 associated with an inside handle 358 can be used to provide for deadlocking (superlocking) i.e., operation of the inside 358 and outside 352 door handles do not cause the door 350 to open.

Alternatively or additionally the block/breaking of the third transmission path 370 associated with an inside handle 358 can be used to provide for a child safety function i.e., operation of the inside handle 358 does not open the door 350, and operation of the outside handle 352 will open an unlocked door 350 but will not open a locked door 350.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. An assembly comprising:
a first component and a second component, the first component having a first deformed portion, in which the first deformed portion engages with the second component to allow rotation therebetween and the first deformed portion secures the first component to the second component.

2. The assembly according to claim 1, in which the second component includes a second deformed portion, the second deformed portion engaging with the first deformed portion to allow rotation therebetween with the first and the second deformed portions cooperating to secure the first component to the second component.

3. A vehicle door latch comprising:
an assembly including a first component and a second component, the first component having a first deformed portion, in which the first deformed portion engages with the second component to allow rotation therebetween and the first deformed portion secures the first component to the second component.

4. The vehicle door latch as defined in claim 3 further including a latch bolt for releasably retaining a door in use, and an input element, in which a transmission path exists between the input element and the latch bolt, the input element being operable to unlatch the latch, the transmission path including the first and the second components, wherein with the latch in an unlocked condition operation of the input element causes the first and the second components to move and release the latch bolt, and with the latch in a locked condition operation of the input element causes one of the first and the second components to rotate relative to the other of the first and the second components.

5. The vehicle door latch as defined in claim 3 further including a latch bolt for releasably retaining a door in use, and an input element, in which a transmission path exists between the input element and the latch bolt, the input element being operable to unlatch the latch, the transmission path being selectively blockable by one of the first and the second components.

6. The vehicle door latch according to claim 3 wherein the second component includes a second deformed portion, the second deformed portion engaging with the first deformed portion to allow rotation therebetween with the first and the second deformed portions cooperating to secure the first component to the second component.

7. The vehicle door latch as defined in claim 6 further including a latch bolt for releasably retaining a door in use, and an input element, in which a transmission path exists between the input element and the latch bolt, the input element being operable to unlatch the latch, the transmission path including the first and the second components, wherein with the latch in an unlocked condition operation of the input element causes the first and the second components to move and release the latch bolt, and with the latch in a locked condition operation of the input element causes one of the first and the second components to rotate relative to the other of the first and the second components.

8. The vehicle door latch as defined in claim 6 further including a latch bolt for releasably retaining a door in use, and an input element, in which a transmission path exists between the input element and the latch bolt, the input element being operable to unlatch the latch, the transmission path being selectively blockable by one of the first and the second components.

9. A vehicle door comprising: an assembly including a first component and a second component, the first component having a first deformed portion, in which the first deformed portion engages with the second component to allow rotation therebetween and the first deformed portion secures the first component to the second component; and
a latch including a latch bolt for releasably retaining the door in use, and a manually actuable element, in which a transmission path exists between the manually actuable element and the latch bolt, the manually actuable element being operable to unlatch the latch, the transmission path including one of the first and the second component of the assembly.

10. The vehicle door according to claim 9 in which the second component further includes a second deformed portion, the second deformed portion engaging with the first deformed portion to allow rotation therebetween with the first and the second deformed portions cooperating to secure the first component to the second component.

12. The vehicle door according to claim 9 in which the transmission path is selectively blockable by one of the first and the second components.

11. The vehicle door according to claim 10 wherein with the latch in an unlocked condition operation of the manually actuable element causes the first and second components to move, and with the latch in a locked condition operation of the manually actuable element causes one of the first and second components to rotate relative to the other of the first and second components.

13. The vehicle door according to claim 10 in which the transmission path further includes the other of the first and the second components.

14. A vehicle door comprising: an assembly including a first component and a second component, the first component having a first deformed portion, in which the first deformed portion engages with the second component to allow rotation therebetween and the first deformed portion secures the first component to the second component; and
a latch connected via a transmission path to a manually actuable element, the manually actuable element being operable to lock and unlock the latch, the transmission path including one of the first and the second component of the assembly.

15 The vehicle door according to claim 14 in which the second component further includes a second deformed portion, the second deformed portion engaging with the first deformed portion to allow rotation therebetween with the first and the second deformed portions cooperating to secure the first component to the second component.

16. The vehicle door according to claim 14 in which the transmission path includes the other of the first and the second components.
